(19) United States
(12) Patent Application Publication
(10) Pub. No.: US 2007/0019056 A1
(43) Pub. Date: Jan. 25, 2007

(54) Method for detecting misregistration in an image forming apparatus

(75) Inventors: Hyun-sun Jung, Suwon-si (KR); Hasegawa Jun, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/430,864

(22) Filed: May 10, 2006

(30) Foreign Application Priority Data
Jul. 20, 2005 (KR) 2005-0066040

(51) Int. Cl. G03G 15/01

(52) U.S. Cl. 347/116

(57) ABSTRACT

A method for detecting misregistration of an image forming apparatus having a plurality of cartridges. The method includes forming a first pattern using one of the plurality of cartridges, the first pattern comprising a plurality of lines that are arranged parallel to one another and incline in one direction by a predetermined angle, forming a second pattern using another cartridge, the second pattern comprising a plurality of lines that are arranged at the same intervals as those of the first pattern, the second pattern being symmetrical to the first pattern, forming critical points on the end most line of at least one of the first and the second patterns in opposite directions away from a center of the end most line by a predetermined distance, and overlapping the first and the second patterns and estimating a degree of misregistration between the first and the second patterns. Accordingly, it is possible to accurately detect the vertical and the horizontal misregistration and also to estimate the degrees of misregistrations as numerical values.

### CROSS REFERENCE TO RELATED APPLICATION

This application claims the benefit under 35 U.S.C. § 119(a) of Korean Patent Application No. 2005-66040, filed on Jul. 20, 2005, in the Korean Intellectual Property Office, the entire content of which is hereby incorporated by reference.

### BACKGROUND OF THE INVENTION

1. Field of the Invention

The present invention relates to a method for detecting misregistration in an image forming apparatus. More particularly, the present invention relates to a method for detecting misregistration in an image forming apparatus, which is capable of accurately detecting vertical and horizontal misregistration and easily estimating the degrees of the vertical and the horizontal misregistration as numerical values.

2. Description of the Related Art

A color laser printer is typically provided with a plurality of color cartridges and a single black cartridge (K), as shown in FIG. 1. The plurality of color cartridges typically comprise cyan (C), magenta (M), and yellow (Y) cartridges. To transfer ink of C, M, Y, and K from the cartridges 5a-d to paper, the color laser printer comprises four organic photoconductors (OPCs) 30a-d, four laser scanning units (LSUs) 10a-d, four developing units 20, a transfer belt 40, a transfer unit 50, and a fusing unit 60.

The OPCs 30 are disposed adjacent to the color cartridges 5, respectively. The OPCs 30 are charged with a predetermined electric potential. The electric potential is discharged by the laser beams, thereby forming electrostatic latent images. The LSUs 10 scan the OPCs 30 with laser beams according to printing data supplied from a user terminal, thereby forming the electrostatic latent images on the OPCs 30. The developing units 20 develop the electrostatic latent images formed on the OPCs 30 using four color developers. Color images developed at the OPCs 30 are attracted to the transfer belt 40. The transfer unit 50 transfers the color images from the transfer belt 40 to the paper and the fusing unit 60 fuses the images onto the paper with heat and pressure.

Upon receiving printing data from a user terminal, such a color laser printer processes (or rasterizes) the print data and classifies the processed data according to the different colors of ink, such as C, M, Y, and K, to form color print data. Then, the LSUs 10 scan the OPCs 30 with laser beams according to the color print data, thereby forming electrostatic latent images for the colors C, M, Y, and K. The developing units 20 develop the electrostatic latent images formed on the OPCs 30 with color developers of C, M, Y, and K, and the color images developed at the OPCs 30 are transferred to paper through the transfer belt 40 and the transfer unit 50. At this time, the developed color images of C, M, Y, and K are required to be correctly transferred to the same location on the paper. In other words, the separate color images must be registered. However, misregistration may occur when the respective color images are transferred out of register due to the complex structure of the color laser printer.

Therefore, various methods for detecting and compensating for misregistration have been suggested. One such method is disclosed in U.S. Pat. No. 5,402,726, which is hereby incorporated by reference in its entirety. In the method of that patent, two of four cartridges are selected to detect misregistration. Print data is input such that dots are printed as shown in FIGS. 2A and 2B. Next, LSUs, OPCs, developing units, a transfer belt, and a transfer unit which correspond to the selected two cartridges are operated to print two color images on paper from the two cartridges.

As shown in FIG. 2A, dots at the center have a circular shape, but dots at distances away from the center have a larger, oval shape. The dots of FIG. 2B are similar to those of FIG. 2A, but the gaps between two dots are slightly different from those of FIG. 2A. Accordingly, if the dots of FIG. 2A and the dots of FIG. 2B are in alignment, a spot at the center is brightest and spots at distances away from the center gradually become darker as shown in FIG. 2C. However, if the dost of FIG. 2A and the dots of FIG. 2B are out of alignment, the bright spot is biased towards one side as shown in FIG. 2D or appears around the edges as shown in FIG. 2E. Whether the color images of the two cartridges are in alignment or out of alignment is determined based on the dot patterns as described above.

The conventional method makes it possible to detect misregistration between print positions of the two cartridges based on the dot patterns, but it cannot estimate how much the print positions of the two cartridges differ or which direction the bright spot is biased because various dot patterns appear according to the overlap size of two dots.

Accordingly, there is a need for an improved method of detecting and estimating the orientation and degree of misregistration in a color image forming apparatus.

### SUMMARY OF THE INVENTION

An aspect of the present invention is to address at least the above problems and/or disadvantages and to provide at least the advantages described below. Accordingly, an aspect of the present invention is to provide a method for detecting misregistration of an image forming apparatus, which is capable of accurately measuring the orientation and the degree of misregistration.

In accordance with an aspect of the present invention, a method for detecting misregistration of an image forming apparatus having a plurality of cartridges is provided. The method comprises the steps of forming a first pattern using one of the plurality of cartridges, the first pattern comprising a plurality of lines that are arranged parallel to one another and incline in one direction by a predetermined angle, forming a second pattern using another cartridge, the second pattern comprising a plurality of lines that are arranged at the same intervals as those of the first pattern, forming critical points on the end most line of at least one of the first and the second patterns in opposite directions away from a center of the end most line by a predetermined distance, and overlapping the first and the second patterns and estimating a degree of misregistration between the first and the second patterns.

Preferably, but not necessarily, a space between two adjacent lines of the first pattern becomes gradually larger in one direction. Preferably, but not necessarily, a space between two adjacent lines of the second pattern becomes gradually larger in one direction.

Preferably, but not necessarily, a reference line is formed on at least one of the first and the second patterns, the reference line forming a predetermined angle with respect to a line perpendicular to the lines of the first and the second patterns.

Preferably, but not necessarily, the critical points are formed on at least one of the first and the second patterns in opposite directions away from the reference line by a predetermined distance.

Preferably, but not necessarily, the first pattern is a top pattern to detect vertical misregistration, the top pattern comprising a plurality of horizontal lines and inclining towards one direction by a predetermined angle, a space between two adjacent horizontal lines becoming gradually larger when moving from the top of the pattern to the bottom of the pattern.

Preferably, but not necessarily, the second pattern is a bottom pattern to detect vertical misregistration, the bottom pattern comprising a plurality of horizontal lines that are arranged in a vertical direction and inclining to be symmetrical to the first pattern.

Preferably, but not necessarily, the reference line is formed on the second pattern in a horizontal direction.

Preferably, but not necessarily, the critical points comprise a left critical point and a right critical point that are formed on the uppermost line of the second pattern in opposite directions away from the reference line by a predetermined distance.

Preferably, but not necessarily, the first pattern is a top pattern to detect horizontal misregistration, the top pattern comprising a plurality of vertical lines that are arranged in a horizontal direction, a space between adjacent two vertical lines becoming gradually larger when moving from the left side of the pattern to the right side.

Preferably, but not necessarily, the second pattern is a bottom pattern to detect horizontal misregistration, the bottom pattern comprising a plurality of vertical lines that are arranged in a horizontal direction.

Preferably, but not necessarily, the reference line is formed on the second pattern in a horizontal direction.

Preferably, but not necessarily, the critical points are an upper critical point and a lower critical point that are formed on the left most line of the second pattern in opposite directions away from the reference line by a predetermined distance.

Preferably, but not necessarily, the method further comprises the steps of printing the top pattern and the bottom pattern to overlap the top pattern and the bottom pattern, photographing an image of the top pattern and the bottom pattern after they are printed, measuring a distance between an intersection point of the top pattern and the bottom pattern and the critical point in the photographed image, and calculating a degree of misregistration between the top pattern and the bottom pattern based on the measured distance as a numerical value.

Preferably, but not necessarily, if the top pattern and the bottom pattern are to detect vertical misregistration, the intersection point of the top pattern and the bottom pattern is formed at the uppermost lines, and the degree of vertical misregistration between the top pattern and the bottom pattern is calculated based on a difference between the intersection point and a right or a left critical point.

Preferably, but not necessarily, if the top pattern and the bottom pattern are to detect horizontal misregistration, the intersection point of the top pattern and the bottom pattern is formed at the first left line, and the degree of horizontal misregistration between the top pattern and the bottom pattern is calculated based on a difference between the intersection point and an upper or a lower critical point.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a view of a conventional color laser printer;

FIGS. 2A to 2E are dot-patterns used in a conventional method for detecting misregistration;

FIGS. 3A and 3B are a top pattern and a bottom pattern, respectively, to detect vertical misregistration in accordance with an exemplary embodiment of the present invention;

FIGS. 3C to 3E are views illustrating the result patterns produced by overlapping the top pattern of FIG. 3A and the bottom pattern of FIG. 3B;

FIGS. 4A and 4B are a top pattern and a bottom pattern, respectively, to detect horizontal misregistration in accordance with an exemplary embodiment of the present invention; and

FIGS. 4C to 4E are views illustrating the result patterns produced by overlapping the top pattern of FIG. 4A and the bottom patter of FIG. 4B.

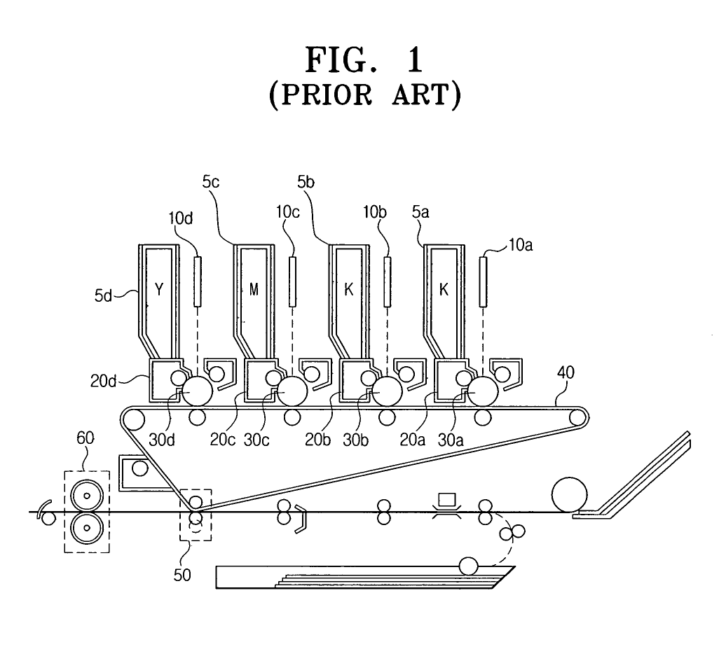

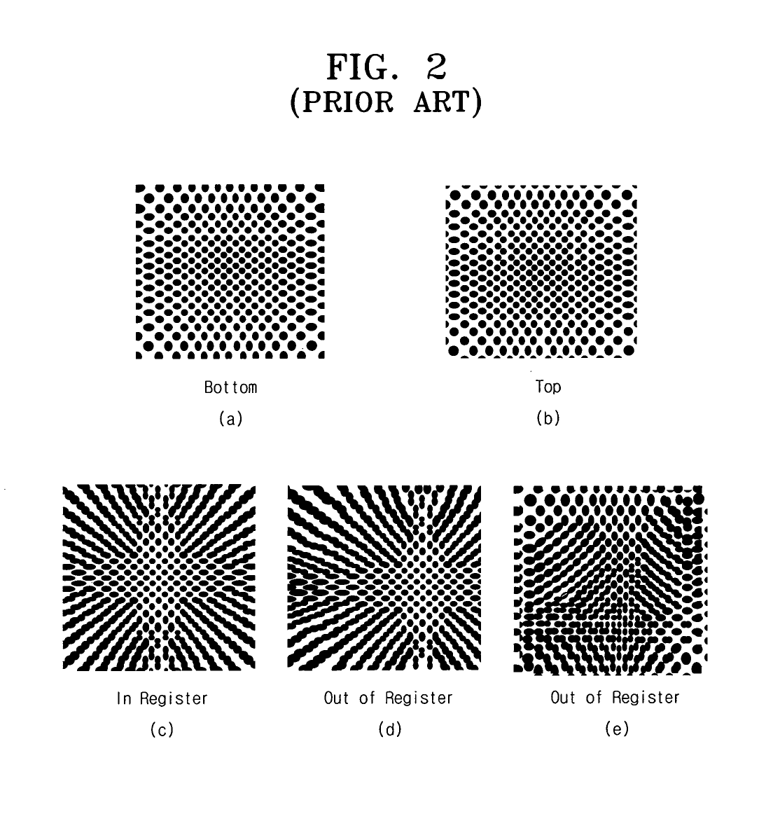

Throughout the drawings, the same reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

An image forming apparatus using the method for detecting misregistration according to the exemplary embodiments of the present invention has the same construction as that of a conventional image forming apparatus. Accordingly, a description of the components of the image forming apparatus is not repeated.

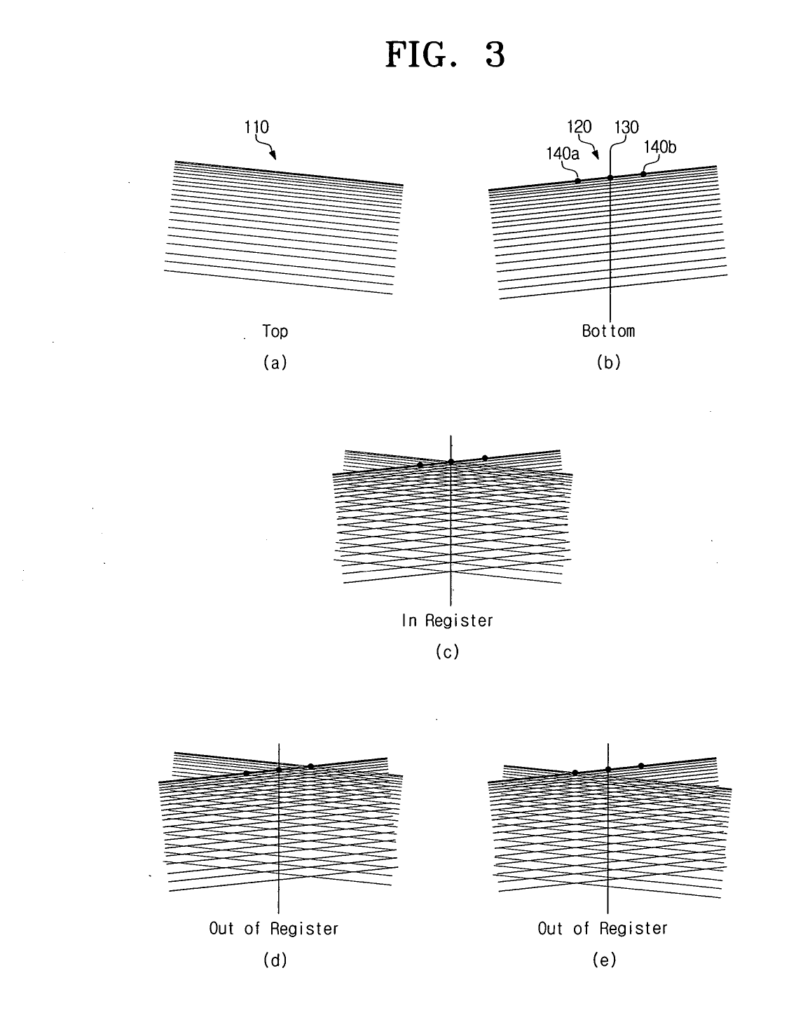

FIGS. 3A and 3B are patterns used to detect vertical misregistration according to an exemplary embodiment of the present invention.

The method for detecting misregistration according to an exemplary embodiment of the present invention detects both vertical misregistration and horizontal misregistration. FIGS. 3A and 3B illustrate patterns to detect vertical misregistration. The patterns to detect vertical misregistration include a top pattern 110 and a bottom pattern 120 which are printed by different color cartridges.

The top pattern 110 comprises a plurality of horizontal lines that are oriented downward at intervals. The space between two adjacent horizontal lines in the pattern becomes gradually larger when moving from the top of the pattern to the bottom of the pattern. The top pattern 110 inclines toward one direction by a predetermined angle.

Similarly, the bottom pattern 120 comprises a plurality of horizontal lines that are arranged such that the space between two adjacent lines becomes gradually larger when moving from the top of the pattern to the bottom of the pattern. The bottom pattern 120 is symmetrical to the top pattern 120 about a vertical line, and thus inclines toward the opposite direction by a predetermined angle. The bottom pattern 120 and the top pattern have the same line spacing and the same inclination angle. The bottom pattern 120 has a vertical reference line 130 formed at a center of the pattern and has a left critical point 140a and a right critical point 140b which are located on the uppermost line of the bottom pattern 120. The left and right critical points 140a, 140b are located on opposite sides of the vertical reference line, and are spaced away from the vertical reference line 130 by the same distance.

The vertical reference line 130 is a reference line to determine whether a moirë pattern formed when the top pattern 110 and the bottom pattern 120 are overlapped is symmetrical or asymmetrical. The left and the right critical points 140a, 140b are used to estimate the degree of misregistration between the top pattern 110 and the bottom pattern 120. If an intersection point where the uppermost lines of the top pattern 110 and the bottom pattern 120 intersect deviates from the left or right critical point 140a, 140b, misregistration, which must be compensate for, is present. When the top pattern 110 and the bottom pattern 120 are not registered in a vertical direction as much as a critical distance, the uppermost lines of the top pattern 110 and the bottom pattern 120 intersect at the left or the right critical point 140a, 140b. Accordingly, based on a difference between the intersection point and the left or right critical point 140a, 140b, the degree of vertical misregistration between the top pattern 110 and the bottom pattern 120 is estimated in a desired unit, such as pixels, millimeters, or micrometers.

When the top pattern 110 and the bottom pattern 120 are overlapped, the result patterns appear as shown in FIGS. 3C, 3D, and 3E. As shown in FIG. 3C, the intersection point of the uppermost lines of the top pattern 110 and the bottom pattern 120 accurately matches the vertical reference line 130 and the moirë patterns formed by the overlapping of the top pattern 110 and the bottom pattern 120 are symmetrical with reference to the vertical reference line 130. Especially, the vertical reference line 130 is positioned through the center moirë. In this case, it is determined that the top pattern 110 and the bottom pattern 120 are properly registered.

FIGS. 3D and 3E show the uppermost lines of the top pattern 110 and the bottom pattern 120 intersecting at the right critical point 140b and the left critical point 140a, respectively. Also, the center moirë formed by the overlapping of the top pattern 110 and the bottom pattern 120 is asymmetrical with reference to the vertical reference line 130. Accordingly, the top pattern 110 and the bottom pattern 120 are out of register in a vertical direction as much as a distance between the vertical reference line 130 and the right and the left critical points 140b, 140a. More specifically, FIG. 3D shows the top pattern 110 being located at a higher position than the bottom pattern 120, and FIG. 3E shows the bottom pattern 120 being located at a higher position than the top pattern 110.

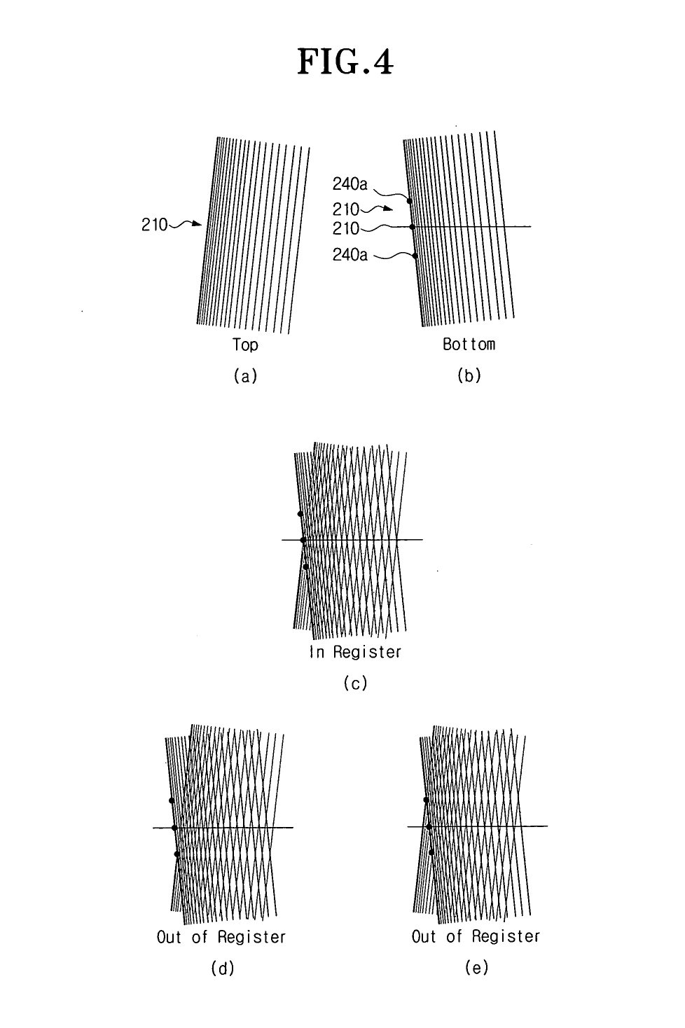

FIGS. 4A and 4B are views illustrating patterns to detect horizontal misregistration according to an exemplary embodiment of the present invention.

Like the patterns to detect vertical misregistration, the patterns to detect horizontal misregistration include a top pattern 210 and a bottom pattern 220 which are printed by different color cartridges.

The top pattern 210 comprises a plurality of vertical lines that are arranged to at intervals from right to left. The space between two horizontal lines becomes gradually larger when moving from the right to the left side of the pattern. Also, the top pattern 210 inclines toward one direction by a predetermined angle.

Like the top pattern 220, the bottom pattern 210 comprises a plurality of vertical lines that are arranged at intervals such that the space between two vertical lines becomes larger when moving from the left to the right side of the pattern. The bottom pattern 220 has the same inclination angle as that of the top pattern 220, but inclines in the opposite direction as the top pattern 220. The bottom pattern 220 has a horizontal reference line 230 formed at the center thereof and also has an upper critical point 240a and a lower critical point 240b which are formed on the first left line in the opposite directions away from the horizontal reference line 230 by the same distance.

When the upper pattern 210 and the bottom pattern 220 are overlaid and thus form a moirë pattern, the horizontal reference line 230 makes it easier to determine whether the moirë pattern is symmetrical or asymmetrical. Based on a distance between the intersection point of the top pattern 210 and the bottom pattern 220 and the upper or the lower critical points 240a, 240b, the degree of horizontal misregistration is estimated as a numerical value.

When the top pattern 210 and the bottom pattern 220 are overlapped, the result patterns appear as shown in FIGS. 4C, 4D, and 4E. As shown in FIG. 4C, the intersection point where the first left lines of the top pattern 210 and the bottom pattern 220 intersect accurately matches the horizontal reference line 230. Also, the moirë patterns formed by the overlapping of the top pattern 210 and the bottom pattern 220 is symmetrical with reference to the horizontal reference line 230. Also, the horizontal reference line 230 is positioned through the center moirë. In this case, it is determined that the top pattern 210 and the bottom pattern 220 are properly registered.

FIGS. 4D and 4E show the first left lines of the top pattern 210 and the bottom pattern 220 that do not intersect at the horizontal reference line 230 but intersect at the lower critical point 240b or the upper critical point 240a. Also, the center moiré formed by overlapping the top pattern 210 and the bottom pattern 220 is asymmetrical with reference to the horizontal reference line 230. Accordingly, it is determined that the top pattern 210 and the bottom pattern 220 are out of register in a horizontal direction as much as a distance between the upper or the lower critical point 240a, 240b and the horizontal reference line 230. As shown in FIG. 4C, the top pattern 210 inclines towards the right side, and on the other hand, the bottom pattern 220 inclines towards the left side.

A method for detecting misregistration using the top patterns 110, 210 and the bottom patterns 120, 220 as described above will now be described. To detect misregistration between two cartridges, an experimenter inputs a pattern output command using, for example, a button. A controller (not shown) provides a LSU of a selected cartridge either the pair of top and bottom patterns 110, 120 to detect vertical misregistration or the pair of top and bottom patterns 210, 220 to detect horizontal misregistration. The top and bottom patterns 110, 210 and 120, 220 may be previously stored in an external device or a memory. Alternatively, both the pair of top and bottom patterns 110, 120 to detect vertical misregistration and the pair of top and bottom patterns 210, 220 to detect horizontal misregistration may be provided to the LSUs of two cartridges.

For example, in order to detect vertical and horizontal misregistrations between the cartridge C and the cartridge M, the controller provides a LSU of the cartridge C with print data about the top patterns 110, 210, and provides a LSU of the cartridge M with print data about the bottom patterns 120, 220. The respective LSUs of the cartridges C and M scan their corresponding OPCs 30 with laser beams and thereby form electrostatic latent images of the top patterns 110, 210 and the bottom patterns 120, 220 on the OPCs 30.

A developing unit of the cartridge C develops the electrostatic latent images of the top patterns 110, 210 using a developer C, and a developing unit of the cartridge M develops the electrostatic latent images of the bottom patterns 120, 220 using a developer M. The developed images of the top patterns 110, 120 and the bottom patterns 120, 220 are attracted to the transfer belt 40 in sequence. A transfer unit 50 transfers the images from the transfer belt 40 to paper and a fusing unit 60 fuses the images of the top patterns 110, 210 and the bottom patterns 120, 220 onto the paper with a heat and a pressure.

When the images of the top patterns 110, 210 and the bottom patterns 120, 220 are fused onto the paper, the result patterns to detect vertical misregistration appear on the paper as shown in FIGS. 3C to 3E, and the result patterns to detect horizontal misregistration appear on the paper as shown in FIGS. 4C to 4E.

Then, the controller photographs the printed result patterns to detect the vertical and the horizontal misregistrations using predetermined photographing means, such as a CCD sensor. The photographed result patterns are transmitted to the controller. The controller measure a distance between the point where the uppermost lines of the top pattern 110 and the bottom pattern 120 intersect and the right critical point 140b or the left critical point 140a and thus determines the degree of vertical misregistration between the top pattern 110 and the bottom pattern 120. In the same way, the controller measures a distance between the point where the first left lines of the top pattern 210 and the bottom pattern 220 and the upper critical point 240a or the lower critical point 240b and thus determines the degree of horizontal misregistration between the top pattern 210 and the bottom pattern 220.

If the degrees of the vertical and horizontal misregistrations between the top patterns 110, 210 and the bottom patterns 120, 220 fall within a pre-set available error range, the controller completes the detecting process. If, however, the degree of misregistration exceeds the available error range, the controller compensates for misregistration. The operation of compensating misregistration may be performed in various ways such as, for example, adjusting the time that print data is provided to the LSUs, or adjusting the locations of the cartridges, the developing units or the OPCs.

According to the method for detecting misregistration as described above, since patterns to detect vertical misregistration and horizontal misregistration are respectively provided, it is possible to detect vertical misregistration and horizontal misregistration, respectively. Also, the degrees of vertical and horizontal misregistrations are easily estimated using the left and the right critical points 140a, 140b and the upper and the lower critical points 240a, 240b.

Although in this exemplary embodiment only one pair of critical points and a single reference line are formed on the bottom pattern 120, 220, they may be formed on the top pattern 110, 210 or may be formed on both the top pattern 110, 210 and the bottom pattern 120, 220.

Also, although in this exemplary embodiment one pair of critical points are provided, a plurality of critical points may be provided at intervals. In this case, the critical points serve as scales so that the degrees of misregistrations between the top patterns 110, 210 and the bottom patterns 120, 220 are more accurately estimated.

According to the exemplary embodiments of the present invention, it is possible to accurately detect the vertical and the horizontal misregistration and also to estimate the degrees of misregistrations as numerical values.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for detecting misregistration of an image forming apparatus having a plurality of cartridges, the method comprising the steps of:
forming a first pattern using one of the plurality of cartridges, the first pattern comprising a plurality of lines that are arranged substantially parallel to one another and incline in one direction by a predetermined angle;
forming a second pattern using another cartridge, the second pattern comprising a plurality of lines that are arranged at the same intervals as those of the first pattern;
forming critical points on the end most line of at least one of the first and the second patterns, the critical points being located in opposite directions away from a center of the end most line by a predetermined distance; and
overlapping the first and the second patterns and estimating a degree of misregistration between the first and the second patterns.

2. The method as claimed in claim 1, wherein
a space between two adjacent lines of the first pattern becomes gradually larger towards one direction.

3. The method as claimed in claim 1, wherein
a space between two adjacent lines of the second pattern becomes gradually larger towards one direction.

4. The method as claimed in claim 3, wherein
a reference line is formed on at least one of the first and the second patterns, the reference line forming a predetermined angle with respect to a line perpendicular to the lines of the first and the second patterns.

5. The method as claimed in claim 4, wherein
the critical points are located in opposite directions away from the reference line by a predetermined distance.

6. The method as claimed in claim 5, wherein
the first pattern is a top pattern to detect vertical misregistration, the top pattern comprising a plurality of horizontal lines inclining towards one direction by a predetermined angle, a space between two adjacent horizontal lines becoming gradually larger when moving from the top of the pattern to the bottom of the pattern.

7. The method as claimed in claim 6, wherein
the second pattern is a bottom pattern to detect vertical misregistration, the bottom pattern comprising a plurality of horizontal lines that are arranged in a vertical direction and are inclined at a symmetrical angle to the angle of the first pattern.

8. The method as claimed in claim 7, wherein
the reference line is formed on the second pattern in a horizontal direction.

9. The method as claimed in claim 8, wherein the critical points comprise
a left critical point and a right critical point that are formed on the uppermost line of the second pattern in opposite directions away from the reference line by a predetermined distance.

10. The method as claimed in claim 5, wherein
the first pattern is a top pattern to detect horizontal misregistration, the top pattern comprising a plurality of vertical lines that are arranged in a horizontal direction, a space between two adjacent vertical lines becoming gradually larger when moving from the left to the right side of the pattern.

11. The method as claimed in claim 10, wherein
the second pattern is a bottom pattern to detect horizontal misregistration, the bottom pattern comprising a plurality of vertical lines that are arranged in a horizontal direction.

12. The method as claimed in claim 11, wherein
the reference line is formed on the second pattern in a horizontal direction.

13. The method as claimed in claim 12, wherein
the critical points are an upper critical point and a lower critical point that are formed on the left most line of the second pattern in opposite directions away from the reference line by a predetermined distance.

14. The method as claimed in claim 1, further comprising the steps of:
printing the top pattern and the bottom pattern to overlap the top pattern and the bottom pattern;
photographing an image of the top pattern and the bottom pattern after they are printed;
measuring a distance between an intersection point of the top pattern and the bottom pattern and the critical point in the photographed image;
calculating a degree of misregistration between the top pattern and the bottom pattern based on the measured distance as a numerical value.

15. The method as claimed in claim 14, wherein,
if the top pattern and the bottom pattern are to detect vertical misregistration, the intersection point of the top pattern and the bottom pattern is formed at the uppermost lines, and the degree of vertical misregistration between the top pattern and the bottom pattern is calculated based on a difference between the intersection point and a right or a left critical point.

16. The method as claimed in claim 14, wherein,
if the top pattern and the bottom pattern are to detect horizontal misregistration, the intersection point of the top pattern and the bottom pattern is formed at the left most line, and the degree of horizontal misregistration between the top pattern and the bottom pattern is calculated based on a difference the intersection point and an upper or a lower critical point.
